(19) United States
(12) Patent Application Publication
(10) Pub. No.: US 2007/0131031 A1
(43) Pub. Date: Jun. 14, 2007

(54) Wireless inertial input device

(75) Inventors: Ming-Jye Tsai, Xinpu Town (TW); Shun-Nan Liou, Kaohsiung City (TW); Chieh-Shiung Chang, Kaohsiung City (TW); Ying-Ko Lu, Guishan Shiang (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/505,851

(22) Filed: Aug. 18, 2006

(30) Foreign Application Priority Data
Dec. 9, 2005 (TW) 094143515

(51) Int. Cl. G01P 15/08; G08C 17/02

(52) U.S. Cl. 73/514.01; 345/156; 340/870.28

(57) ABSTRACT

The present invention relates to a wireless inertial input device of low power consumption. The wireless inertial input device uses an inertial sensing cell, being arranged therein, to generate a sensing signal to be received and processed by a processor for enabling the processor to generate a response signal to be applied by an electric device, whereas the inertial sensing cell is communicating with the processor wirelessly as the processor is not physically connected to the inertial sensing cell and is electrically connected to the electric device. By separating the high power consuming processor from the wireless inertial input device as the sensing signal generated by the inertial sensing cell arranged inside the wireless inertial input device is transmitted wirelessly to the processor to be processed, the power consumption of the wireless inertial input device is reduced and thus the duration of batteries used thereby can be increased.

### FIELD OF THE INVENTION

The present invention relates to a wireless inertial input device, and more particularly, to a wireless inertial input device of low power consumption which separates a high power consuming signal processor from the chassis of the same while enabling an inertial sensing cell arranged inside the wireless inertial input device to communicate with the processor by a wireless communication means and thus reducing the power consumption of the wireless inertial input device.

### BACKGROUND OF THE INVENTION

With the rapid development and popularization of computers, more and more attention had been paid to the development of more user-friendly human-machine interface for facilitating the applications of computers. Currently, there are many kinds of computer mouse, especially wireless optical mouse, available on the market, which are the most popular human-machine interface used by computers as cursor-control device. Most conventional wireless optical mice includes an optical sensing module, a micro processing unit, a wireless communication module, a power module, and so on.

Motion of this conventional optical mouse was detected by sensing the variations in the intensity of light reflected from the special surface. In contrast, a more recently developed optical mouse was disclosed in U.S. Pat. No. 6,664,948, as shown in FIG. 1A, which employs a red light emitting diode (LED) source to illuminate an adjacent surface over which the mouse 1 is being moved. Moreover, the optical mouse 1 of FIG. 1A uses an image detector 10 arranged therein to produce an analog signal to be converted by an analog-to-digital converter 11 into a digital signal for producing a pixel image of a portion of the surface in response to the red light reflected from the surface. It is expected that the wireless optical mouse 1 will capture image frames with the image detector at a rate of about several thousands of frame per second (fps), e.g. 2300 fps, so as to ensure a cursor to move smoothly on a display screen in response to the movement of the optical mouse 1. The image signals from the image detector 10 are compared with a reference image by a signal processing circuit 12 where the comparison are calculated and encoded to obtain a cross correlation from which a displacement signal of ΔX component and ΔY component in response to the mouse movement can be determined. Thereafter, the displacement signal of ΔX component and ΔY component is send to a computer 14 for controlling the cursor displayed on the screen thereof to move accordingly. However, the image processing algorithm used in the aforesaid wireless optical mouse 1 is too complicated that the power consumption thereof can achieve as high as 41 milliampere (mA).

Furthermore, please refer to FIG. 1B, which is a schematic diagram depicting the operation of an inertial pointing device disclosed in TW Pat. No. 0519263. In FIG. 1B, the inertial pointing device 2 of uses an X-axis accelerometer 20 and a Y-axis accelerometer 30 to determine the accelerations of the pointing device 2 relative to x and y orthogonal axes, and then uses a microprocessor 22 to process the signals of detected accelerations, such that motions of a user holding the pointing device 2 can be detected no matter the user is moving slowly, stop, or adjusting his gesture, etc. Preferably, the microprocessor 22 is a low-pass processor, which is capable of converting the acceleration signals detected by the two accelerometers 20, 21 into computer-recognizable signals to be transmitted by a transmitter 24 and thus received by a receiver 24 of a computer 25 for controlling the cursor displayed on the screen thereof to move accordingly. Operationally, the power consumption of the inertial pointing device 2 is about 20 mA, which is mostly due to that the microprocessor 22 is required to process the acceleration signals detected by two accelerometers constantly and continuously. Although the power consumption of the inertial pointing device 2 is lower than the optical mouse 1 shown in FIG. 1A, it is hard to save more power while the microprocessor 22 is constantly processing the acceleration signals without stop.

From the above description, it is noted that most conventional mice will process all the signals required for controlling a cursor of a computer by themselves and then transmit a control signal to the computer for directing the movement of the cursor. Therefore, the power consumption of conventional mice is adversely affected by those complicated calculations of signal processing. It is intended by the present invention to provide a wireless inertial input device of low power consumption for overcoming the aforesaid shortcoming.

### SUMMARY OF THE INVENTION

In view of the disadvantages of prior art, the primary object of the present invention is to provide a wireless inertial input device of low power consumption which separates a high power consuming signal processor from the chassis of the same while enabling an inertial sensing cell arranged inside the wireless inertial input device to communicate with the processor by a wireless communication means and thus reducing the power consumption of the wireless inertial input device.

Another object of the present invention is to provide a wireless inertial input device of low power consumption capable of using an inertial sensing cell, being arranged therein, to generate a sensing signal to be received and processed by a processor for enabling the processor to generate a response signal to be applied by a electric device, wherein the inertial sensing cell is communicating with the processor wirelessly as the processor is not physically connected to the inertial sensing cell and is electrically connected to the electric device.

To achieve the above objects, the present invention provides a wireless inertial input device of low power consumption, comprising an inertial sensing cell, that the inertial cell further comprises: an inertial sensor, capable of detecting a movement of the wireless inertial input device for generating a sensing signal; an interface control unit; and a radio frequency (RF) transmit control unit, being electrically connected to the inertial sensor and the interface control unit, capable of receiving the sensing signal and a signal from the interface control unit for enabling the same to issue a wireless signal accordingly.

Preferably, the interface control signal is capable of generating an interface control signal with respect to the movement of the wireless inertial input device. Moreover, the wireless signal includes the interface control signal.

Preferably, the inertial sensing cell further comprises a pulse storage, which is coupled to the RF transmit control unit and is used for storing the sensing signal and the interface control signal.

Preferably, the RF transmit control unit further comprises: a radio frequency (RF) transmitter; and an encoding controller, coupled to the RF transmitter, capable of receiving and encoding the sensing signal and the interface control signal for enabling the RF transmitter to proceed with a wireless transmission accordingly.

Preferably, the inertial sensor further comprises at least an inertial sensing part, which can be a device selected from the group consisting of a uniaxial accelerometer, a multi-axial accelerometer, and a gyroscope.

Preferably, the specifications of the wireless signal is defined by a protocol selected form the group consisting of Blue tooth, ultra wideband (UWB), wireless fidelity (Wi-Fi) and Zigbee.

In a preferred embodiment, the wireless inertial sensing device further comprises a processor, which is electrically connected to an electric device and is capable receiving and decoding the wireless signal for enabling the same to generate a response signal to be applied by a electric device. The processor further comprises: a radio frequency (RF) receive control unit, for receiving the wireless signal while decoding the received wireless signal into the sensing signal and the interface control signal; and a micro processing unit, couple to the RF receive control unit, capable of processing the sensing signal and the interface control signal while transmitting a result of the processing to the electric device. The RF receive control unit further comprises: a radio frequency (RF) receiver; and a decoding controller, coupled to the RF receiver, for receiving and decoding the wireless signal transmitted form the RF receiver.

Preferably, the micro processing unit is coupled to an interface control unit, which is used to receive the result of the processing from the micro processing unit while transmitting the received result to the electric device.

Preferably, the wireless inertial device is a device selected from the group consisting of a mouse, a remote control, a joystick, and a pointer.

Preferably, the processor is coupled to the electric device by a universal serial bus (USB) interface.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1A is a functional block diagram illustrating the components used in an optical mouse disclosed in U.S. Pat. No. 6,664,948.

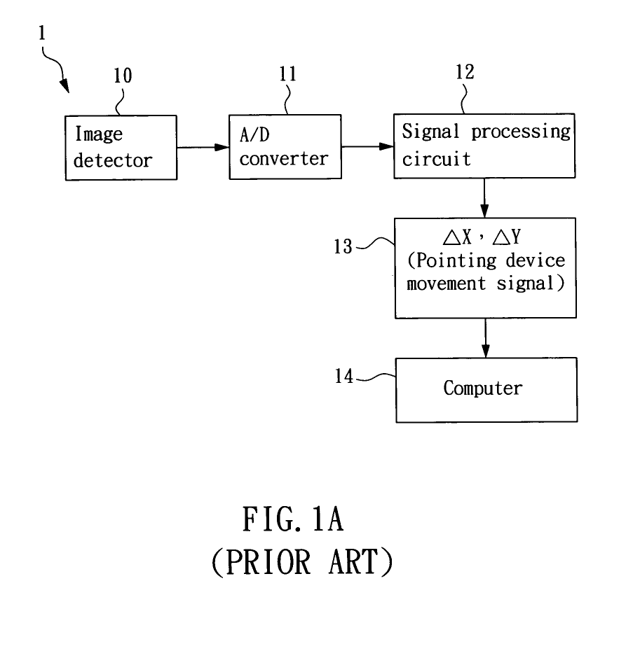

FIG. 1B is a schematic diagram depicting the operation of an inertial pointing device disclosed in TW Pat. No. 0519263.

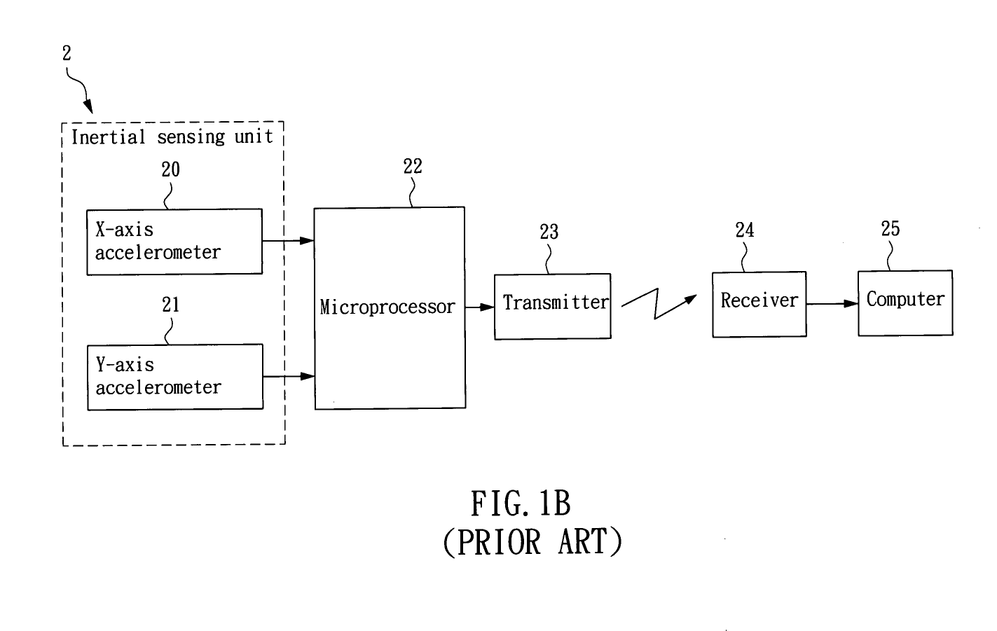

FIG. 2 is a schematic diagram showing a wireless inertial input device of low power consumption according to the present invention.

FIG. 3A is a schematic diagram showing an inertial sensing cell of a wireless inertial input device of low power consumption according to a preferred embodiment of the present invention.

FIG. 3B is a schematic diagram showing a processor of a wireless inertial input device of low power consumption according to a preferred embodiment of the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

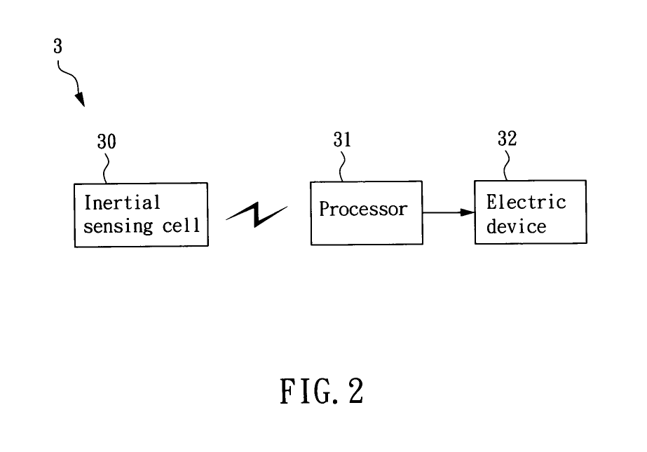

Please refer to FIG. 2, which is a schematic diagram showing a wireless inertial input device of low power consumption according to the present invention. As shown in FIG. 2, a wireless inertial input device 3 utilizes an inertial sensing cell 30 to generate a sensing signal to be received and processed by a processor 31 for enabling the processor 31 to generate a response signal to be applied by an electric device 32, which is characterized in that: the inertial sensing cell 30 is arranged in the wireless input device 3 and is communicating with the processor 32 by a wirelessly means as the processor 31 is not physically connected to the inertial sensing cell 30 and is electrically connected to the electric device 32. It is noted that the electric device 32 is capable of supplying power to the processor 30.

Moreover, the inertial sensing cell 30 is able to encode a received sensing signal, such as an acceleration signal, into a RF signal and then transmit the RF signal to the processor 31, whereas the encoding is to identify the characters containing in the acceleration signal received by the receiving end of the inertial sensing cell 30, such as the acceleration measured along a X-axis, the acceleration measured along a Y-axis or the rotation of the inertial input device 3, and so on. Thereafter, the processor 31 will use a specific algorithm to decode the sensing signal received thereby for converting the same in to a signal capable of being recognized by the electric device 32, such as the two-phase signal for USB controller, and thus directing the electric device to act accordingly. For instance, as the wireless inertial input device 30 is a mouse and the electric device 32 is a computer, the cursor displayed on the screen of the computer is controlled to move according to the movement of the mouse. The electric device 32 can be a computer, a stationary mainframe or a mobile mainframe, such as an electronic entertainment device or a multimedia processor. In addition, the wireless inertial input device 30 can be a mouse, a joystick, a pointer, or a remote control, but is not limited thereby.

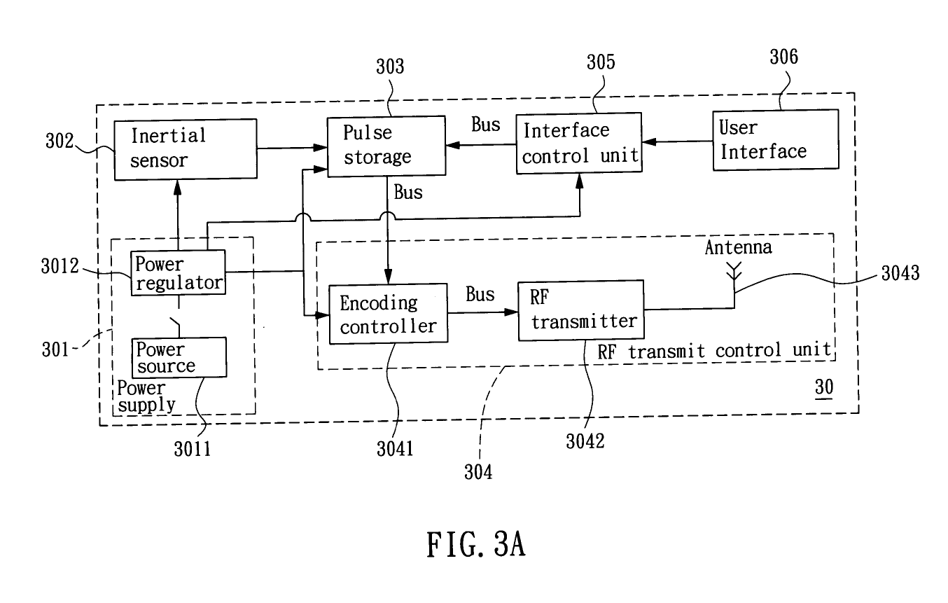

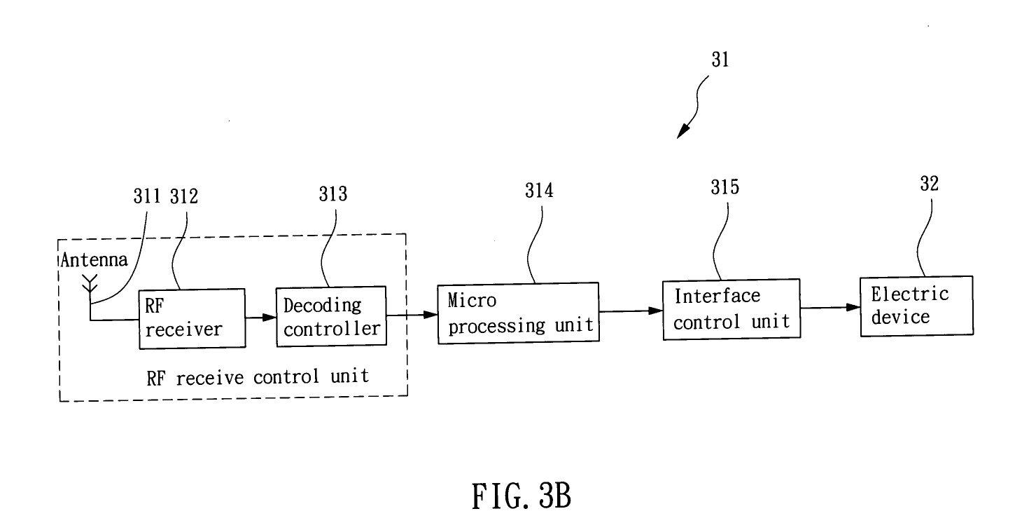

Please refer to FIG. 3A, which is a schematic diagram showing an inertial sensing cell of a wireless inertial input device of low power consumption according to a preferred embodiment of the present invention. As shown in FIG. 3A, the inertial sensing cell 30 is arranged in a wireless inertial input device for detecting and receiving an operation signal issue by a user of the wireless inertial input device and thus providing a sensing signal accordingly. The inertial sensing cell 30 is comprised of a power supply 301, an inertial sensor 302, a pulse storage 303, an interface control unit 305 and a RF transmit control unit 304.

The power supply 30 is used to provide power to the inertial sensor 302, the pulse storage 303, then interface control unit 305 and the RF transmit control unit 3.04, which is composed of a power source 3011 and a power regulator 3012. The inertial sensor 301 is comprised of at least an inertial sensing part, which is capable of detecting and measuring degree-of-freedom, surface motion, space motion and rotation and thus providing a sensing signal accordingly. The amount of inertial sensing part being configured in the inertial sensor 301 is dependent on actual detection requirement In addition, the inertial sensing part can be a device selected from the group consisting of a uniaxial accelerometer, a multi-axial accelerometer, and a gyroscope, but is not limited thereby.

The interface control unit 305 is capable of receiving signals transmitted from a user interface 306 and outputting an interface control signal accordingly. For instance, as the wireless inertial input device 30 is a mouse and the user interface 305 is a button or roller arranged on the mouse, when the button is pressed or the roller is rolled by a user, the interface control unit.305 will be informed with the mechanical motion for enabling the same to issue an interface control signal.

In order to reduce the operating frequency of the inertial sensing cell 30 so as to save the power consumption thereof, a shared register mechanism is adopted by the wireless inertial input device of the invention that a pulse storage 303 is provided to be shared and accessed by the inertial sensor 302 and the interface control unit 305. That is, both the sensing signal and the interface control signal are being stored in the pulse storage 303. The RF transmit control unit 304 further comprises a encoding controller 3041, a RF transmitter 3042, and a transmitting antenna 3043, that the encoding controller 3041 is coupled to the pulse storage 303 for fetching the interface control signal and the sensing signal stored in the-same to be encoded thereby, and then the encoded signals are send to the RF transmitter 3042 to be emitted through the transmitting antenna 3043 wirelessly. It is noted that the specifications of the wireless emitted signal can be defined by a protocol selected form the group consisting of Blue tooth, ultra wideband (UWB), wireless fidelity (Wi-Fi) and Zigbee. In another preferred embodiment of the invention, the interface control signal can be transited directly to the encoding controller 3041 by way of an internal bus to be encoded without having to be processed and stored by the pulse storage 303 before being transmitted to the encoding controller 3041, and thereafter, similarly that the encoded signal is send to the RF transmitter 3042 to be emitted through the transmitting antenna 3043.

Please refer to FIG. 3B, which is a schematic diagram showing a processor of a wireless inertial input device of low power consumption according to a preferred embodiment of the present invention. The processor 31 of FIG. 3 is similar to that shown in FIG. 2 which is electrically connect to an electric device 32 and is used for receiving signals transmitted from the transmitting antenna 3043. In the processor 31 shown in FIG. 3B, the wireless signal emitted by the inertial sensing cell 30 is received by a RF receiver 312 coupled to a receiving antenna 311, and then the received signal is sent to an decoding controller 313 to be decoded and restored into the original interface control signal and the sensing signal for enabling a micro processing unit 314 to issue a movement signal according to the two signals, and finally, the movement signal is transmitted to electric device 32 by way of an interface control unit 315. After the electric device 32 receives the movement signal, the electric device will operate in response to the movement signal, such as to control the cursor displayed on the screen of the electric device 32 to move in response to the movement signal. Since the power for sustaining the operation of the processor 31 can be supplied by the electric device 32, the power consumption of the wireless inertial input device of the present invention is greatly reduced comparing to those conventional input devices. Furthermore, the processor 31 can be connected to the electric device 32 by way of a universal serial bus (USB) interface.

In general, the power consumption of the wireless inertial input device of the present invention can be greatly reduced comparing to those conventional input devices, since the high power consuming processor is separated from the wireless inertial input device as the sensing signal is generated in a manner of detecting and fetching a signal every other 10 ms form the inertial sensor by the inertial sensing cell arranged inside the wireless inertial input device while the generated sensing signal is transmitted wirelessly to the processor to be processed, and moreover, the inertial sensor is manufactured by a micro-electro-mechanical (MEM) process. As the Table 1 listed below, power consumption of the inertial sensing cell of the present invention is reduced by about 0.6 mA, and power consumption of the micro processing unit f the present invention is reduced by about 1 mA, such that the overall power consumption of the wireless inertial input device of the invention is about 15 mA that enables the duration of batteries used thereby to be several times comparing to those conventional input devices. Not only the power consumption of the invention is greatly reduced, but also the efficiency of inertial sensing signal processing is greatly enhanced thereby.

TABLE 1
which is a chart illustrating the power consumption comparison
between devices or prior arts and the wireless inertial
input device of the invention.

| Wireless optical | | Wireless inertial input device | | | | |
|---|---|---|---|---|---|---|
| input device | | | | | Present | |
| | US6664948 | | TW0519263 | | invention | |
| Optical | ˜15 mA | Inertial sensing | ˜0.6 | mA | ˜0.6 | mA |
| sensing | | cell | | | | |
| module | | | | | | |
| Micro | ˜13 mA | Micro | ˜5 | mA | ˜1 | mA |
| processing | | processing unit | | | | |
| unit | | | | | | |
| RF | ˜13 mA | RF transmitter | ˜13 | mA | ˜13 | mA |
| transmitter | | | | | | |
| Total power | ˜41 mA | Total power | ˜18.6 | mA | ˜14.6 | mA |
| consumption | | consumption | | | | |

To sum up, by separating the high power consuming processor from the wireless inertial input device as the sensing signal generated by the inertial sensing cell arranged inside the wireless inertial input device is transmitted wirelessly to the processor to be processed, the power consumption of the wireless inertial input device is reduced and thus the duration of batteries used thereby can be increased.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A wireless inertial input device having an inertial sensing cell arranged therein, the inertial cell, comprising:
an inertial sensor, capable of detecting a movement of the wireless inertial input device for generating a sensing signal; and
a radio frequency (RF) transmit control unit, being electrically connected to the inertial sensor, capable of receiving the sensing signal for enabling the same to issue a wireless signal accordingly.

2. The wireless inertial input device of claim 1, wherein the inertial sensing cell further comprises a pulse storage, coupled to the RF transmit control unit for storing the sensing signal.

3. The wireless inertial input device of claim 1, wherein the RF transmit control unit, further comprising:
a radio frequency (RF) transmitter, coupled to an transmitting antenna; and
an encoding controller, coupled to the RF transmitter, capable of receiving and encoding the sensing signal for controlling the RF transmitter to proceed with a wireless transmission accordingly.

4. The wireless inertial input device of claim 1, wherein the inertial sensor further comprises at least an inertial sensing part.

5. The wireless inertial input device of claim 4, wherein the inertial sensing part is a device selected from the group consisting of a uniaxial accelerometer, a multi-axial accelerometer, and a gyroscope.

6. The wireless inertial input device of claim 1, wherein the specifications of the wireless signal is defined by a protocol selected form the group consisting of Blue tooth, ultra wideband (UWB), wireless fidelity (Wi-Fi) and Zigbee.

7. The wireless inertial input device of claim 1, further comprising a processor electrically connected to an electric device, capable receiving and decoding the wireless signal for enabling the same to generate a response signal to be applied by a electric device.

8. The wireless inertial input device of claim 7, wherein the processor, further comprising:
a radio frequency (RF) receive control unit, for receiving the wireless signal while decoding the received wireless signal into the sensing signal; and
a micro processing unit, couple to the RF receive control unit, capable of processing the sensing signal while transmitting a result of the processing to the electric device.

9. The wireless inertial input device of claim 8, wherein the RF receive control unit, further comprising:
a radio frequency (RF) receiver, coupled to a receiving antenna and
a decoding controller, coupled to the RF receiver, for receiving and decoding the wireless signal transmitted form the RF receiver.

10. The wireless inertial input device of claim 7, wherein the electric device is a device selected from the group consisting of a computer, a stationary mainframe and a mobile mainframe.

11. The wireless inertial input device of claim 7, wherein the processor is connected to the electric device by a universal serial bus (USB) interface.

12. A wireless inertial input device, capable of using an inertial sensing cell to generate a sensing signal to be received and processed by a processor for enabling the processor to generate a response signal to be applied by an electric device, characterized in that: the inertial sensing cell is arranged in the wireless input device and is communicating with the processor by a wirelessly means as the processor is not physically connected to the inertial sensing cell and is electrically connected to the electric device.

13. A wireless inertial input device having an inertial sensing cell arranged therein, the inertial cell, comprising:
an inertial sensor, capable of detecting a movement of the wireless inertial input device for generating a sensing signal;
an interface control unit, capable of generating an interface control signal with respect to the movement of the wireless inertial input device; and
a radio frequency (RF) transmit control unit, being electrically connected to the inertial sensor and the interface control unit, capable of receiving the sensing signal and an interface control signal from the interface control unit for enabling the same to issue a wireless signal accordingly.

14. The wireless inertial input device of claim 13, wherein the inertial sensing cell further comprises a pulse storage, coupled to the RF transmit control unit and the interface control unit for storing the sensing signal and the interface control signal.

15. The wireless inertial input device of claim 13, wherein the RF transmit control unit, further comprising:.
a radio frequency (RF) transmitter, coupled to an transmitting antenna; and
an encoding controller, coupled to the RF transmitter, capable of receiving and encoding the sensing signal and the interface control signal for controlling the RF transmitter to proceed with a wireless transmission accordingly.

16. The wireless inertial input device of claim 13, wherein the inertial sensor further comprises at least an inertial sensing part.

17. The wireless inertial input device of claim 16, wherein the inertial sensing part is a device selected from the group consisting of a uniaxial accelerometer, a multi-axial accelerometer, and a gyroscope.

18. The wireless inertial input device of claim 13, wherein the specifications of the wireless signal is defined by a protocol selected form the group consisting of Blue tooth, ultra wideband (UWB), wireless fidelity (Wi-Fi) and Zigbee.

19. The wireless inertial input device of claim 13, further comprising a processor electrically connected to an electric device, capable receiving and decoding the wireless signal for enabling the same to generate a response signal to be-applied by a electric device.

20. The wireless inertial input device of claim 19, wherein the processor, further comprising:
a radio frequency (RF) receive control unit, for receiving the wireless signal and the interface control signal while decoding the received wireless signal into the sensing signal; and
a micro processing unit, couple to the RF receive control unit, capable of processing the sensing signal and the interface control signal while transmitting a result of the processing to the electric device.

21. The wireless inertial input device of claim 20, wherein the RF receive control unit, further comprising:
a radio frequency (RF) receiver, coupled to a receiving antenna; and
a decoding controller, coupled to the RF receiver, for receiving and decoding the wireless signal transmitted form the RF receiver.

22. The wireless inertial input device of claim 20, wherein the micro processing unit is further coupled to an interface control unit, being used to receive the result of the processing from the micro processing unit while transmitting the received result to the electric device.

23. The wireless inertial input device of claim 20, wherein the electric device is a device selected from the group consisting of a computer, a stationary mainframe and a mobile mainframe.

24. The wireless inertial input device of claim 20, wherein the processor is connected to the electric device by a universal serial bus (USB) interface.
